(19) United States
(12) Patent Application Publication
(10) Pub. No.: US 2020/0137067 A1
(43) Pub. Date: Apr. 30, 2020

(54) TIMELINE FOR USER AND ENTITY BEHAVIOR ANALYTICS

(71) Applicant: HEWLETT PACKARD ENTERPRISE DEVELOPMENT LP, Houston, TX (US)

(72) Inventors: Brijesh Nambiar, Santa Clara, CA (US); Dhiraj Sharan, Brookings, SD (US); Mahesh Garg, Sunnyvale, CA (US)

(21) Appl. No.: 16/177,029

(22) Filed: Oct. 31, 2018

(51) Int. Cl. H04L 29/06; H04W 4/021

(52) U.S. Cl. CPC H04L 63/102; H04W 4/021; H04L 63/1425; H04L 63/0245

(57) ABSTRACT

Methods and systems for attributing monitored network activity to a user are provided. In one aspect, a method includes receiving profile data associated with a user and monitored network activity data. The method includes attributing at least one network activity associated with at least one client device to the user. The method also includes generating a timeline comprising an event at a particular time point on the timeline corresponding to the at least one network activity associated with the at least one client device that is attributed to the user; updating the timeline to include subsequent network activities of the monitored network activity data that are attributed to the user; and monitoring the timeline to detect at least one security anomaly based on the updated timeline.

### BACKGROUND

In some private networks, such as in enterprise environments, users login to one or more devices to access network resources. The users typically then use these devices that are connected to the enterprise network to access resources, such as applications and services hosted internally in the enterprise network, as well as applications and services hosted externally to the enterprise network such as cloud applications or partner services. It is often important, from a security perspective, to monitor network activities that may be observed from data sources such as network data, application data, and the like.

The description provided in the background section should not be assumed to be prior art merely because it is mentioned in or associated with the background section. The background section may include information that describes one or more aspects of the subject technology.

### BRIEF DESCRIPTION OF THE DRAWINGS

The accompanying drawings, which are included to provide further understanding and are incorporated in and constitute a part of this specification, illustrate disclosed embodiments and, together with the description, serve to explain the principles of the disclosed embodiments. In the drawings:

FIG. 1 illustrates an example architecture for monitoring network activity on a network and correlating the network activity to a user associated with a device connected to the network.

FIG. 2 is a block diagram illustrating example client device(s) and network devices from the architecture of FIG. 1 according to certain aspects of the disclosure.

FIG. 3 illustrates an example process for monitoring network activity on a network and correlating the network activity to a user associated with a device connected to the network using the example client devices and network devices of FIG. 2.

FIG. 4 illustrates an example illustration associated with the example process of FIG. 3.

FIG. 5 is a block diagram illustrating an example computer system with which the example client device(s) and network devices of FIG. 2 may be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art will realize, the described implementations may be modified in various different ways, all without departing from the scope of the present disclosure. Accordingly, the drawings and description are to be regarded as illustrative in nature and not restrictive.

### General Overview

The disclosed system provides for tracking network activity data of multiple client devices connected to a network and attributing at least one network activity of the network activity data to a user on the network. For example, the user joins the network by logging in on at least one client device. Once the user joins the network, a header is generated to include profile data such as, for example, but not limited to, user name, user status, user email address, user contacts, login time, logout time, access privileges, department associated with the user, group associated with the user, and the like. A network device, such as a User and Entity Behavior Analytics server, receives monitored network activity data and attributes network activity associated with the at least one client device to the user. The network device generates a timeline associated with the header. The timeline includes tracking data such as, but not limited to, user location, device name associated with the at least one client device being used by the user, device type associated with the at least one client device being used by the user, security posture of the at least one client device being used by the user, and the like, as well as, all network activity attributed to the user. The timeline is monitored to detect security anomalies based on the network activity attributed to the user.

The disclosed system addresses a technical problem tied to computer technology and arising in the realm of computer networks, namely the technical problem of computer viruses and anomalous activity on the network. As an example, the disclosed system solves this technical problem by improving computer network security, such as by attributing network activity to the user on the network and identifying an anomalous network activity attributed to the user as a security anomaly for enforcing security policies against the user. Additionally, the disclosed system improves computer network security by attributing network activities to users with the user status of guest user. For example, a timeline is generated and associated with a header including the profile data of the guest user, such that the timeline includes all the network activity attributed to the guest user. The timeline is monitored to detect security anomalies based on the network activity attributed to the guest user.

In one aspect of the present disclosure, a computer-implemented method is described that includes receiving, at a first network device from a second network device, profile data associated with a user. The computer-implemented method also includes receiving, at the first network device from a third network device, monitored network activity data on a network, the monitored network activity data comprising at least one network activity associated with at least one client device. The computer-implemented method also includes attributing, at the first network device, the at least one network activity associated with the at least one client device to the user. The computer-implemented method also includes generating, at the first network device, a timeline comprising an event at a particular time point on the timeline corresponding to the at least one network activity associated with the at least one client device that is attributed to the user. The computer-implemented method also includes updating, at the first network device, the timeline to include subsequent network activities of the monitored network activity data that are attributed to the user. The computer-implemented method also includes monitoring, at the first network device, the timeline to detect at least one security anomaly based on the updated timeline.

In another aspect, a system is described that includes a memory storing instructions and one or more processors configured to execute the instructions to receive profile data associated with a user. The one or more processors also execute instructions to receive monitored network activity data comprising at least one network activity associated with at least one client device. The one or more processors also execute instructions to attribute the at least one network activity associated with the at least one client device to the user. The one or more processors also execute instructions to generate a timeline comprising an event at a particular time point on the timeline corresponding to the at least one network activity associated with the at least one client device that is attributed to the user. The one or more processors also execute instructions to update the timeline to include subsequent network activities of the monitored network activity data that are attributed to the user. The one or more processors also execute instructions to monitor the timeline to detect at least one security anomaly based on the updated timeline. The one or more processors also execute instructions to detect the at least one security anomaly. The one or more processors also execute instructions to transmit a notification that the at least one security anomaly is detected. The one or more processors also execute instructions to enforce a security policy against the user.

In yet another aspect, a non-transitory machine-readable storage medium is described that includes machine-readable instructions, which when executed by one or more processors, cause a computer to perform a method, the method including receiving, at a User and Entity Behavior Analytics (UEBA) server from a Policy Manager server, profile data associated with a user. The method also includes receiving, at the User and Entity Behavior Analytics server from a network monitoring server, monitored network activity data on a network, the monitored network activity data comprising at least one network activity associated with at least one client device. The method also includes attributing, at the User and Entity Behavior Analytics server, the at least one network activity associated with the at least one client device to the user. The method also includes generating, at the User and Entity Behavior Analytics server, a timeline comprising an event at a particular time point on the timeline corresponding to the at least one network activity associated with the at least one client device that is attributed to the user. The method also includes updating, at the User and Entity Behavior Analytics server, the timeline to include subsequent network activities of the monitored network activity data that are attributed to the user. The method also includes monitoring, at the User and Entity Behavior Analytics server, the timeline to detect at least one security anomaly based on the updated timeline.

In yet another aspect, a system is described that includes a means for receiving profile data associated with a user. The system also includes a means for receiving monitored network activity data on a network, the monitored network activity data comprising at least one network activity associated with at least one client device. The means for receiving monitored network activity also attributes the at least one network activity associated with the at least one client device to the user. For example, the means can attribute the at least one network activity associated with the at least one client device to the user based on login data received from a network server. The means for receiving monitored network activity also generates a timeline comprising an event at a particular time point on the timeline corresponding to the at least one network activity associated with the at least one client device that is attributed to the user. The means for receiving monitored network activity also updates the timeline to include subsequent network activities of the monitored network activity data that are attributed to the user. The means for receiving monitored network activity also monitors the timeline to detect at least one security anomaly based on the updated timeline. The system also includes a means for enforcing a security policy against the user.

### Example System Architecture

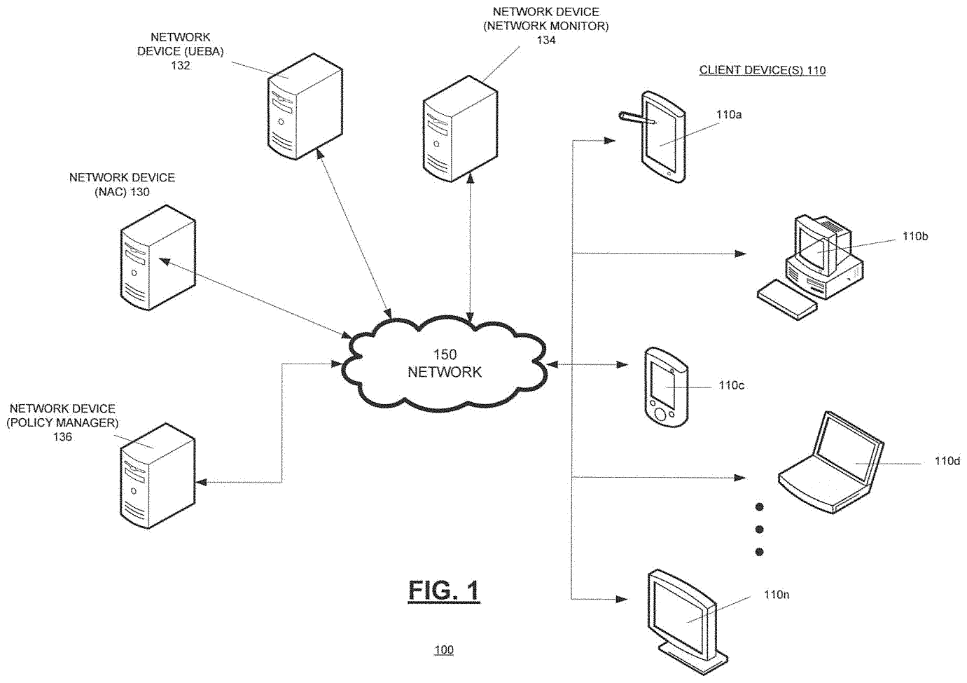

FIG. 1 illustrates an example architecture 100 for monitoring network activity on a network and attributing the network activity to a user associated with a device connected to the network. The architecture 100 includes one or more client device 110 (e.g., client devices 110a to 110n) and network devices 130-136 connected over a network 150.

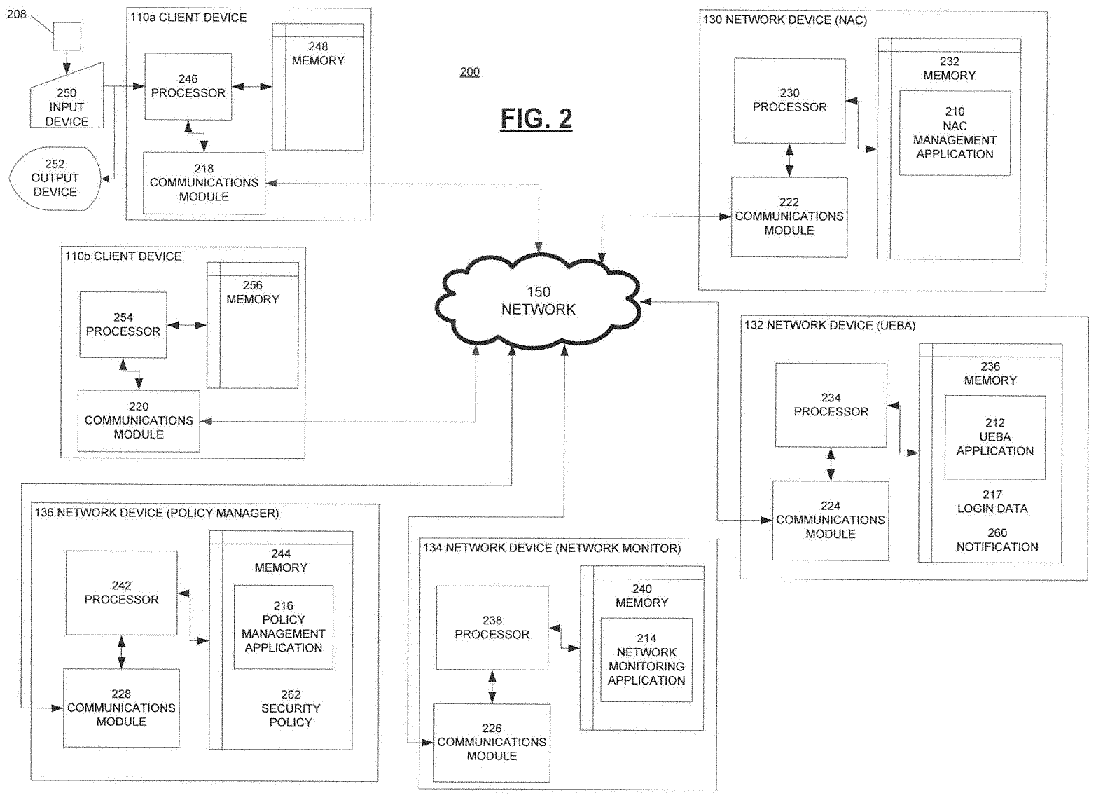

The network device 130 is configured to host a Network Access Control (NAC) management application 210 (see FIG. 2) that manages and controls any of the network devices 132-136. For purposes of load balancing, a plurality of network devices 130 may host the NAC management application 210. The network device 130 may be any device comprising an appropriate processor, memory, and communications capability for hosting the NAC management application 210, such as, but not limited to, a centralized network server (e.g., a centralized NAC server) capable of implementing NAC management and security enforcement.

The network device 132 is configured to host a User and Entity Behavior Analytics (UEBA) application 212 (see FIG. 2) that receives monitored network activity for detecting security anomalies. For purposes of load balancing, a plurality of network devices 132 may host the UEBA application 212. The network device(s) 132 may be any device comprising an appropriate processor, memory, and communications capability for hosting the UEBA application 212, such as, but not limited to, a UEBA server capable of implementing security anomaly detection.

The network device 134 is configured to host a network monitoring application 214 (see FIG. 2) that monitors network activity data and transmits such monitored network activity data to the network device 132. For purposes of load balancing, a plurality of network devices 134 may host the network monitoring application 214. The network device(s) 134 may be any device comprising an appropriate processor, memory, and communications capability for hosting the network monitoring application 214 capable of monitoring network activity data and transmitting such monitored network activity data to the network device 132.

The network device 136 is configured to host a Policy Manager application 216 (see FIG. 2) that authenticates user login data 217 for access to the network 150 and determines whether a security policy 262 (see FIG. 2) is enforced against a user 208 (see FIG. 2). For purposes of load balancing, a plurality of network devices 136 may host the network the Policy Manager application 216. The network device(s) 136 may be any device comprising an appropriate processor, memory, and communications capability for hosting the Policy Manager application 216, such as, but not limited to, a Policy Manager server capable of authenticating user login data 217, such as user name and password, and determining whether security policies are enforced.

The client devices 110, including client devices 110a, 110b, . . . 110n, to which the network devices 130, 132, 134, 136 are connected over the network 150 may be, for example, desktop computers, mobile computers, tablet computers (e.g., including e-book readers), mobile devices (e.g., a smartphone or PDA), set top boxes (e.g., for a television), Internet-of-Things (IoT) devices, and/or other devices having appropriate embedded processor, memory, and communications capabilities for accessing resources on the network 150.

The network 150 can include, for example, any one or more of a personal area network (PAN), a local area network (LAN), a campus area network (CAN), a metropolitan area network (MAN), a wide area network (WAN), a broadband network (BBN), an enterprise private network, and the like. Further, the network 150 can include, but is not limited to, any one or more of the following network topologies, including a bus network, a star network, a ring network, a mesh network, a star-bus network, tree or hierarchical network, and the like. The network may be wired or wireless, as mentioned hereinbelow.

### Example Timeline Security Analytics System

FIG. 2 is a block diagram illustrating a system 200 comprising the client devices 110 and the network devices 130, 132, 134, 136 shown in the architecture 100 of FIG. 1 according to certain aspects of the disclosure.

In this example, the client devices 110 further comprise first and second clients 110a, 110b. The first and second clients 110a, 110b and the network devices 130, 132, 134, 136 are connected over the network 150 via respective communications modules 218, 220, 222, 224, 226, 228. The communications modules 218, 220, 222, 224, 226, 228 are configured to interface with the network 150 to transmit and receive information, such as data, requests, responses, and commands to other devices on the network. The communications modules 218, 220, 222, 224, 226, 228 may be, for example, modems, Ethernet cards, and/or other suitable communications hardware/software.

The network device 130, for example a NAC server, includes a processor 230, the communications module 222, and a memory 232 that includes the NAC management application 210. The processor 230 of the network device 130 is configured to execute instructions, such as instructions physically coded into the processor 230, instructions received from software in memory 232, instructions delivered from a remote memory, or a combination thereof. For example, the processor 230 of the network device 130 executes instructions, from the NAC management application 210, to receive login data 217 associated with a user 208 from the client device 110a and to transmit the login data 217 to the network device 244 for authentication of the login data 217. The processor 230 of the network device 130 also executes instructions, from the network device 136, to enforce the security policy 262 against the user 208.

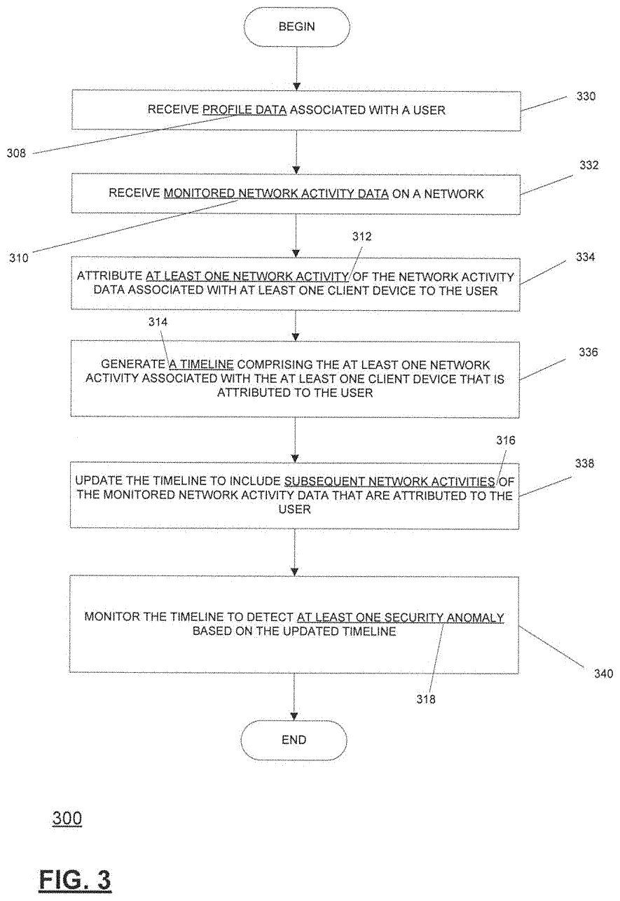

The network device 132, for example a UEBA server, includes a processor 234, the communications module 222, and a memory 236 that includes the UEBA application 212. In certain aspects, the network device 132 detects potential intrusions and malicious activities at least in part through processing baselining user activity and behavior and peer group analysis. The processor 234 of the network device 132 is configured to execute instructions, such as instructions physically coded into the processor 234, instructions received from software in memory 236, instructions delivered from a remote memory, or a combination thereof. For example, the processor 234 of the network device 132 is configured to execute instructions to receive profile data 308 (see FIG. 3) associated with the user 208. In certain aspects, the processor 234 of the network device 132 can receive the profile data 308 from the network device 136. The processor 234 is also configured to execute instructions to receive monitored network activity data 310 (see FIG. 3) on the network 150. In certain aspects, the monitored network activity data 310 is monitored by the network device 134. In certain aspects, the monitored network activity data 310 includes at least one network activity 312 (see FIG. 3) that is associated with at least one client device 110. With the received monitored network activity data 310, the processor 234 of the network device 132 is also configured to execute instruction to attribute the at least one network activity 312 associated with the at least one client device 110 to the user 208 based on the login data 217 received from the network server 136.

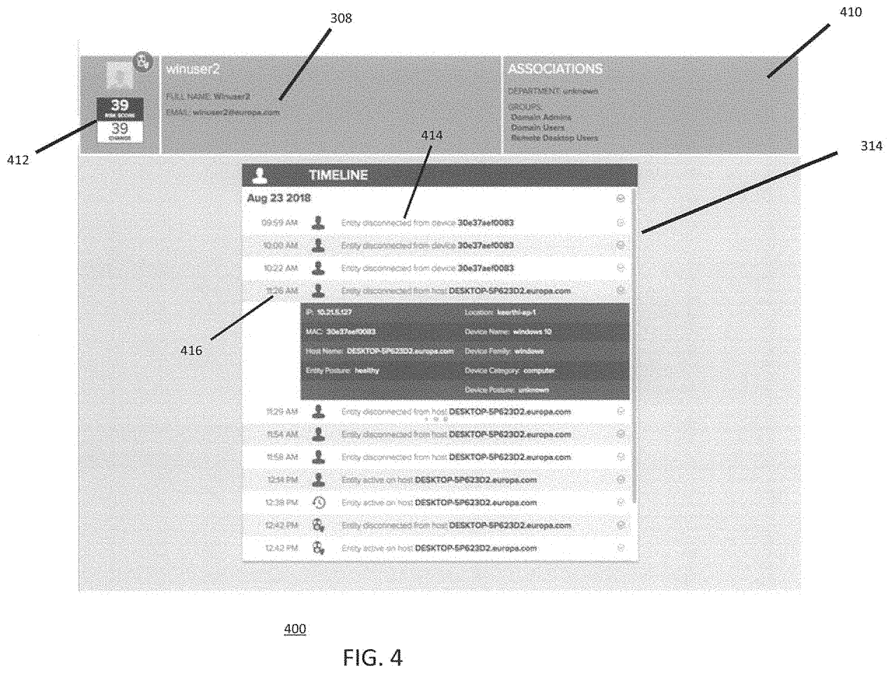

The processor 234 is also configured to execute instructions to attribute the at least one network activity 312 associated with the at least one client device 110 to the user 208. The processor 234 is also configured to execute instructions to generate a timeline 314 (see FIG. 3). In certain aspects, the timeline 314 includes an event 414 (see FIG. 4) at a particular time point 416 (see FIG. 4) on the timeline 314 corresponding to the at least one network activity 312 associated with the at least one client device 110 that is attributed to the user 208. The processor 234 is also configured to execute instructions to update the timeline 314 to include subsequent network activities 316 of the monitored network activity data 310 that are attributed to the user 208. The processor 234 is also configured to execute instructions to monitor the timeline 314 to detect at least one security anomaly 318 (see FIG. 3) based on the at least one network activity 312 associated with the at least one client device 110 that is attributed to the user 208 and the subsequent network activities 316 attributed to the user 208.

The network device 134, for example a network monitoring server, includes a processor 238, the communications module 226, and a memory 240 that includes the network monitoring application 214. The processor 238 of the network device 134 is configured to execute instructions, such as instructions physically coded into the processor 238, instructions received from software in memory 240, instructions delivered from a remote memory, or a combination thereof. For example, the processor 238 of the network device 134 is configured to execute instructions to monitor network activity (e.g., the monitored network activity data 312) on the network 150. The processor 238 is also configured to execute instructions to transmit the monitored network activity data 312 to the network device 132.

The network device 136, for example a Policy Manager server, includes a processor 242, the communications module 228, and a memory 244 that includes the policy manager application 216. In certain aspects, the network device 136 authenticates login data 217 for onboarding the client devices 110, such as, for example, employee and guest devices. The processor 242 of the network device 136 is configured to execute instructions, such as instructions physically coded into the processor 242, instructions received from software in memory 244, instructions delivered from a remote memory, or a combination thereof. For example, in certain aspects, the processor 238 of the network device 136 is configured to execute instructions to receive login data 217 from the network device 130 and authenticate the login data 217. The processor 238 is also configured to execute instructions to transmit, in response to the login data 217 being authenticated, the login data 217, as well as profile data 308, to the network device 132. In certain aspects, the profile data 308 includes, but is not limited to, user name, user status, user email address, user contacts, login time, logout time, access privileges, department associated with the user, group associated with the user, and the like.

The processor 238 is also configured to execute instructions to receive, from the network device 132, a notification 260 (see FIG. 2) indicating that the at least one security anomaly 318 is detected. In certain aspects, the processor 238 is also configured to transmit, in response to receiving the notification 260, instructions to the network device 130 to enforce the security policy 262 against the user 208. For example, the network device 130 can enforce a security policy 262, such as blacklisting the user 208 or denying the user 208 from accessing the network, against the user 208.

Although the functionalities of the network devices 130, 132, 134, 136 are described above as being on separate network devices, it is to be understood that the functionalities of any of the network devices 130, 132, 134, 136 can be combined into a single network device in any various combinations.

The first client device 110a includes a processor 246, the communications module 218, and a memory 248. The client 110a also comprises an input device 250, such as a keyboard, mouse, and/or another suitable input device, and an output device 252, such as a display, port, transducer, and/or another suitable output device. The processor 246 of the first client device 110a is configured to execute instructions, such as instructions physically coded into the processor 246, instructions received from software in memory 248, instructions delivered from a remote memory, or a combination thereof. For example, in certain aspects, the processor 246 of the first client device 110a executes instructions to transmit data, including login data 217 entered on the input device 250 by, for example, a user, to the network device 130.

The second client device 110b, for example an IoT device, includes a processor 254, the communications module 220, and a memory 256. The processor 254 of the second client device 110b is configured to execute instructions, such as instructions physically coded into the processor 254, instructions received from software in memory 256, instructions delivered from a remote memory, or a combination thereof. For example, the processor 254 of the client device 110b executes instructions to transmit access credentials to the network device 130 for authentication to access the network 150.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of steps of the method(s).

FIG. 3 illustrates an example process 300 for monitoring network activity on a network 150 and attributing the at least one network activity 312 of the monitored network activity 310 to the user 208 associated with the client device 110a connected to the network 150 using the example network devices 130, 132, 134, 136 of FIG. 2. While FIG. 3 is described with reference to the system 200 of FIG. 2, it should be noted that the process steps of FIG. 3 may be performed by other systems having more or fewer components as compared with the system 200 of FIG. 2.

The process 300 begins by proceeding to step 330 when the network device 132 receives, from the network device 136, the profile data 308 associated with the user 208. At step 332, the network device 132 receives, from the network device 134, the monitored network activity data 310 on the network 150. The monitored network activity data 310 includes the at least one network activity 312 associated with the at least one client device 110. The network device 132 attributes the at least one network activity 310 associated with the at least one client device 110 to the user 208, as illustrated at step 334. At step 336, the network device 132 generates the timeline 314, which includes the at least one network activity 310 associated with the at least one client device 110 that is attributed to the user 208.

As illustrated at step 338, the network device 132 updates the timeline 314 to include subsequent network activities 316 of the monitored network activity data 310 that are attributed to the user 208. At step 340, the network device 132 monitors the timeline 314 to detect at least one security anomaly 318 based on the at least one network activity 312 associated with the at least one client device 110 that is attributed to the user 208 and the subsequent network activities attributed to the user 208 and the process 300 ends.

FIG. 4 illustrates an exemplary screenshot 400 illustrating the timeline 314 displayed with the corresponding header 410. The header 410 displays the profile data 308. While the profile data 308 in the header 410 includes user name, user email address, department associated with the user, and group associated with the user, in certain aspects, the header 410 can also display user status, user contacts, access privileges, and the like. In certain aspects, the header 410 also displays a risk score 412. The risk score 412 can be calculated by the network device 132 to identify a security risk level associated with the user 208. The timeline 314 can display login time and logout time of the user 208 to the network 150.

For example, with reference to the example process 300 illustrated in FIG. 3 and the exemplary screenshot 400 illustrated in FIG. 4, the user 208 can input the login data 217 into the client device 110a. If the user status of the user 208 is an employee, for example, the network server 136 can, responsive to receiving the login data 217, determine whether the login data 217 is present in a directory. When the network server 136 determines that the user 208 as employee is present in the directory, the network server 136 authenticates the user 208 and the client device 110a associated to the user 208, as an employee, can join the network 150. If the use status of the user 208 is, on the other hand a guest, for example, the user 208 will register onto the client device 110a by providing visitor information such as, but not limited to, company name, sponsor name, and the like. When the network server 136 authenticates the user 208 as a guest, the client device 110a associated to the user 208, as a guest, can join the network 150.

Once the user 208 has joined the network 150, either as employee or guest, the network device 132 is notified that the user 208 is on the network 150 and receives the profile data 308. With the profile data 308, the network device 132 populates the header 410 to include the profile data 308. The network device 132 also generates the timeline 314 associated with the header 410. For example, the timeline 314 can include the login time of the user 208. The network device 132 monitors the timeline 314 and tracks, for example, user location. If the network device 132 determines or detects that the user location is outside of an authorized area (e.g., unauthorized location), then the network device 312 transmits the notification 260 to the network device 136 indicating that the at least one security anomaly 318 is detected. The network device 136 determines whether to enforce the security policy 262 against the user 208 and, based on a determination that the security policy 262 be enforced, transmits instructions to the network device 130 to enforce the security policy 262.

As another example, the network device 132 may monitor the timeline 314 and detect the user 208 accessing an authorized website or launching an authorized application. In a similar manner, the network device 132 can then transmit the notification 260 to the network device 136 to determine whether to enforce the security policy 262 against the user 208.

### Hardware Overview

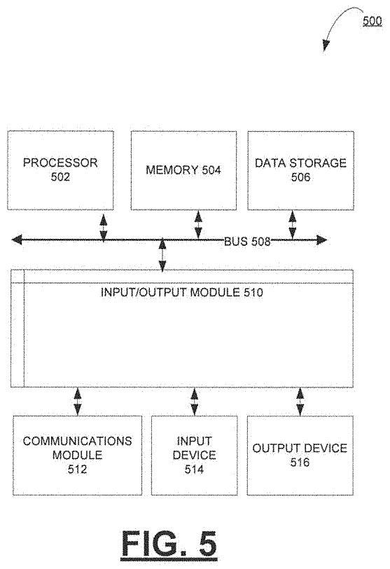

FIG. 5 is a block diagram illustrating an example computer system 500 with which the client devices 110 (e.g., 110a . . . 110n) and the network devices 130, 132, 134, 136 of FIG. 2 can be implemented. In certain aspects, the computer system 500 may be implemented using hardware or a combination of software and hardware, either in a dedicated server, integrated into another computing component, or distributed across multiple computing components.

Computer system 500 (e.g., the client devices 110 and the network devices 130, 132, 134, 136) may include a bus 508 and/or another suitable communication mechanism for communicating information, and one or more processors 502 (e.g., processors 230, 236, 238, 242, 246, 254) coupled with the bus 508 for processing information. According to one aspect, the computer system 500 can be a cloud computing server of an IaaS that is able to support PaaS and SaaS services. According to an example embodiment, the computer system 500 is implemented as one or more special-purpose computing devices. The special-purpose computing device may be hard-wired to perform the disclosed techniques, and/or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination thereof. Such special-purpose computing devices may also combine custom hard-wired logic, ASICs, or FPGAs with custom programming to accomplish the techniques contemplated hereinthroughout. The special-purpose computing devices may be desktop computer systems, portable computer systems, handheld devices, networking devices, and/or any other device that incorporates hard-wired and/or program logic to implement the techniques. By way of example, the computer system 500 may be implemented with the one or more processors 502. The one or more processors 502 may comprise a general-purpose microprocessor, a microcontroller, a Digital Signal Processor (DSP), an ASIC, a FPGA, a Programmable Logic Device (PLD), a controller, a state machine, gated logic, discrete hardware components, or any other suitable entity that can perform calculations or other manipulations of information.

The computer system 500 may include, in addition to hardware, code that creates an execution environment for the computer program in question, e.g., code that constitutes processor firmware, a protocol stack, a database management system, an operating system, or a combination of one or more of them stored in an included memory 504 (e.g., memory 232, 236, 240, 244, 248, 256), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, and/or any other suitable storage device of combination of storage devices, coupled to the bus 508 for storing information and instructions to be executed by the one or more processors 502. The processor(s) 502 and the memory 504 can be supplemented by, or incorporated in, special purpose logic circuitry. Expansion memory may also be provided and connected to computer system 500 through input/output module 510, which may include, for example, a SIMM (Single In Line Memory Module) card interface. Such expansion memory may provide extra storage space for computer system 500, or may also store applications or other information for computer system 500. Specifically, expansion memory may include instructions to carry out or supplement the processes described above, and may further include secure information. Thus, for example, expansion memory may be provided as a security module for computer system 500, and may be programmed with instructions that permit secure use of computer system 500. In addition, secure applications may be provided via the SIMM cards, along with additional information, such as placing identifying information on the SIMM card in a non-hackable manner.

The instructions may be stored in the memory 504 and implemented in one or more computer program products, e.g., one or more modules of computer program instructions encoded on a computer readable medium for execution by, or to control the operation of, the computer system 500, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). The memory 504 may also be used for storing temporary variables or other intermediate information during execution of instructions to be executed by the processor(s) 502.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network, such as in a cloud-computing environment. The processes and logic flows described in this specification can be performed by one or more programmable processors executing one or more computer programs to perform functions by operating on input data and generating output.

Computer system 500 further includes a data storage device 506 such as a magnetic disk or optical disk, coupled to bus 508 for storing information and instructions. Computer system 500 may be coupled via input/output module 510 to various devices. The input/output module 510 can be any input/output module. Example input/output modules 510 include data ports such as USB ports. In addition, input/output module 510 may be provided in communication with the processor(s) 502, so as to enable near area communication of computer system 500 with other devices. The input/output module 510 may provide, for example, for wired communication in some implementations, or for wireless communication in other implementations, and multiple interfaces may also be used. The input/output module 510 is configured to connect to a communications module 512. The communications modules 512 (e.g., communications modules 218, 220, 222, 224, 226, 228) may comprise networking interface cards, such as Ethernet cards and/or modems.

The components of the system can be interconnected by any form or medium of digital data communication, e.g., a communication network. The communication network (e.g., network 150) can include, for example, any one or more of a personal area network (PAN), a local area network (LAN), a campus area network (CAN), a metropolitan area network (MAN), a wide area network (WAN), a broadband network (BBN), the Internet, an enterprise private network, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

For example, in certain aspects, the communications module 512 can provide a two-way data communication coupling to a network link that is connected to a local network. Wireless links and wireless communication may also be implemented. Wireless communication may be provided under various modes or protocols, such as GSM (Global System for Mobile Communications), Short Message Service (SMS), Enhanced Messaging Service (EMS), or Multimedia Messaging Service (MMS) messaging, CDMA (Code Division Multiple Access), Time division multiple access (TDMA), Personal Digital Cellular (PDC), Wideband CDMA, General Packet Radio Service (GPRS), or LTE (Long-Term Evolution), among others. Such communication may occur, for example, through a radio-frequency transceiver. In addition, short-range communication may occur, such as using a BLUETOOTH, WI-FI, or other such transceiver.

In any such implementation, the communications module 512 sends and receives electrical, electromagnetic or optical signals that carry digital data streams representing various types of information. The network link typically provides data communication through one or more networks to other data devices. For example, the network link of the communications module 512 may provide a connection through local network to a host computer or to data equipment operated by an Internet Service Provider (ISP). The ISP in turn provides data communication services through the world wide packet data communication network now commonly referred to as the “Internet”. The local network and Internet both use electrical, electromagnetic or optical signals that carry digital data streams. The signals through the various networks and the signals on the network link and through the communications module 512, which carry the digital data to and from the computer system 500, are example forms of transmission media.

The computer system 500 can send messages and receive data, including program code, through the network(s), the network link and communications module 512. In the Internet example, a server might transmit a requested code for an application program through the Internet, the ISP, the local network, and the communications module 512. The received code may be executed by the processor(s) 502 as it is received, and/or stored in the data storage device 506 for later execution.

In certain aspects, the input/output module 510 is configured to connect to a plurality of devices, such as an input device 514 (e.g., input device 250) and/or an output device 516 (e.g., output device 252). Example input devices 514 include a keyboard and a pointing device, e.g., a mouse or a trackball, by which a user can provide input to the computer system 500. Other kinds of input devices 514 can be used to provide for interaction with a user as well, such as a tactile input device, visual input device, audio input device, or brain-computer interface device.

According to one aspect of the present disclosure, the client devices 110 and the network devices 130, 132, 134, 134, 136 can be implemented using the computer system 500 in response to the processor(s) 502 executing one or more sequences of one or more instructions contained in the memory 504. Such instructions may be read into the memory 504 from another machine-readable medium, such as the data storage device 506. Execution of the sequences of instructions contained in the memory 504 causes the processor(s) 502 to perform the process steps described herein. One or more processors in a multi-processing arrangement may also be employed to execute the sequences of instructions contained in the memory 504. The processor(s) 502 may process the executable instructions and/or data structures by remotely accessing the computer program product, for example by downloading the executable instructions and/or data structures from a remote server through the communications module 512 (e.g., as in a cloud-computing environment). In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. For example, some aspects of the subject matter described in this specification may be performed on a cloud-computing environment. Accordingly, in certain aspects a user of systems and methods as disclosed herein may perform at least some of the steps by accessing a cloud server through a network connection. Further, data files, circuit diagrams, performance specifications and the like resulting from the disclosure may be stored in a database server in the cloud-computing environment, or may be downloaded to a private storage device from the cloud-computing environment.

As mentioned hereinabove, the computing system 500 may include clients and servers. A client and server are generally remote from each other and typically interact through a communication network. The relationship of client and server arises by virtue of computer programs running on the respective computers and having a client-server relationship to each other. The computer system 500 can be, for example, and without limitation, a desktop computer, laptop computer, or tablet computer. Computer system 500 can also be embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer-readable medium” as used herein refers to any medium or media that participates in providing instructions or data to the processor(s) 502 for execution. The term “storage medium” as used herein refers to any non-transitory media that store data and/or instructions that cause a machine to operate in a specific fashion. Such a medium may take many forms, including, but not limited to, non-volatile media, volatile media, and transmission media. Non-volatile media include, for example, optical disks, magnetic disks, or flash memory, such as the data storage device 506. Volatile media include dynamic memory, such as the memory 504. Transmission media include coaxial cables, copper wire, and fiber optics, including the wires that include the bus 508. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

As used in this specification of this application, the terms “computer-readable storage medium” and “computer-readable media” are entirely restricted to tangible, physical objects that store information in a form that is readable by a computer. These terms exclude any wireless signals, wired download signals, and any other ephemeral signals. Storage media is distinct from but may be used in conjunction with transmission media. Transmission media participates in transferring information between storage media. For example, transmission media includes coaxial cables, copper wire and fiber optics, including the wires that include bus 508. Transmission media can also take the form of acoustic or light waves, such as those generated during radio-wave and infra-red data communications. Furthermore, as used in this specification of this application, the terms “computer”, “server”, “processor”, and “memory” all refer to electronic or other technological devices. These terms exclude people or groups of people. For the purposes of the specification, the terms display or displaying means displaying on an electronic device.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for”.

What is claimed is:

1. A method comprising:
receiving, at a first network device from a second network device, profile data associated with a user;
receiving, at the first network device from a third network device, monitored network activity data on a network, the monitored network activity data comprising at least one network activity associated with at least one client device;
attributing, at the first network device, the at least one network activity associated with the at least one client device to the user;
generating, at the first network device, a timeline comprising an event at a particular time point on the timeline corresponding to the at least one network activity associated with the at least one client device that is attributed to the user;
updating, at the first network device, the timeline to include subsequent network activities of the monitored network activity data that are attributed to the user; and
monitoring, at the first network device, the timeline to detect at least one security anomaly based on the updated timeline.

2. The method of claim 1, wherein the first network device is a User and Entity Behavior Analytics (UEBA) server that detects potential intrusions and malicious activities at least in part through processing baselining user activity and behavior and peer group analysis.

3. The method of claim 1, wherein the second network device is a Policy Manager server that authenticates login data.

4. The method of claim 1, wherein the third network device is a network monitoring server that monitors network activity data.

5. The method of claim 1, wherein the timeline is associated with a header, the header comprising the profile data associated with the user.

6. The method of claim 1, further comprising:
detecting, by the first network device, the at least one security anomaly;
transmitting, from the first network device to the second network device, a notification that the at least one security anomaly is detected; and
enforcing, in response to the notification, a security policy against the user.

7. The method claim 6, wherein the profile data identifies the user as a guest.

8. The method claim 7, wherein the at least one security anomaly that is detected indicates a user location associated with the guest as an unauthorized location.

9. The method of claim 8, wherein enforcing the security policy against the user comprises blacklisting the user on the network.

10. The method of claim 8, wherein enforcing the security policy against the user comprises denying the user from accessing the network.

11. The method of claim 1, wherein the timeline further comprises a user location associated with the user, a device type associated with the at least one client device, and a security posture associated with the at least one client device.

12. A system comprising:
a memory comprising instructions; and
one or more processors configured to execute the instructions to:
receive profile data associated with a user;
receive monitored network activity data comprising at least one network activity associated with at least one client device;
attribute the at least one network activity associated with the at least one client device to the user;
generate a timeline comprising an event at a particular time point on the timeline corresponding to the at least one network activity associated with the at least one client device that is attributed to the user;
update the timeline to include subsequent network activities of the monitored network activity data that are attributed to the user;
monitor the timeline to detect at least one security anomaly based on the updated timeline;
detect the at least one security anomaly;
transmit a notification that the at least one security anomaly is detected; and
enforce a security policy against the user.

13. The system of claim 12, wherein the timeline is associated with a header, the header comprising the profile data associated with the user.

14. The system of claim 12, wherein the profile data identifies the user as a guest.

15. The system of claim 14, wherein the at least one security anomaly that is detected indicates a user location associated with the guest as an unauthorized location.

16. The system of claim 14, wherein the instruction to enforce the security policy against the user comprises blacklisting the user on the network.

17. The system of claim 14, wherein the instruction to enforce the security policy against the user comprises denying the user from accessing the network.

18. The system of claim 12, wherein the timeline further comprises a user location associated with the user, a device type associated with the at least one client device, and a security posture associated with the at least one client device.

19. A non-transitory machine-readable storage medium comprising machine-readable instructions for causing a processor to execute a method, the method comprising:
receiving, at a User and Entity Behavior Analytics server from a Policy Manager server, profile data associated with a user;
receiving, at the User and Entity Behavior Analytics server from a network monitoring server, monitored network activity data on a network, the monitored network activity data comprising at least one network activity associated with at least one client device;
attributing, at the User and Entity Behavior Analytics server, the at least one network activity associated with the at least one client device to the user;
generating, at the User and Entity Behavior Analytics server, a timeline comprising an event at a particular time point on the timeline corresponding to the at least one network activity associated with the at least one client device that is attributed to the user;
updating, at the User and Entity Behavior Analytics server, the timeline to include subsequent network activities of the monitored network activity data that are attributed to the user; and
monitoring, at the User and Entity Behavior Analytics server, the timeline to detect at least one security anomaly based on the updated timeline.

20. The non-transitory machine-readable storage medium of claim 19, further comprising:
detecting, by the User and Entity Behavior Analytics server, the at least one security anomaly;
transmitting, from the User and Entity Behavior Analytics server to the Policy Manager server, a notification that the at least one security anomaly is detected; and
enforcing, in response to the notification, a security policy against the user.
